(19) United States
(12) Patent Application Publication
(10) Pub. No.: US 2007/0079679 A1
(43) Pub. Date: Apr. 12, 2007

(54) Saw

(76) Inventors: Mirco Rossetti, Perugia (IT); Marcello Bettacchini, Perugia (IT)

Correspondence Address: THE BLACK & DECKER CORPORATION, 701 EAST JOPPA ROAD, TW199, TOWSON, MD, 21286, US

(21) Appl. No.: 11/544,240

(22) Filed: Oct. 6, 2006

(30) Foreign Application Priority Data
Oct. 7, 2005 (GB) GB0520409.4

(51) Int. Cl. B23D 45/04

(52) U.S. Cl. 83/490

(57) ABSTRACT

A saw having a base assembly having a mounting portion and a saw unit pivotally mounted to the mounting portion. The saw unit is pivotable from an uppermost position away from the base assembly to a lowermost postion towards the base assembly. A locking mechanism locks the saw unit relative to the base assembly when the saw unit is in its uppermost position and in a position closest to the mounting portion.

### BACKGROUND

The present invention relates to powered saws having a chopping and sliding function.

Chop saws typically comprise a motor unit pivotally mounted on a base. The motor unit is located above the base and can pivot between a high position where it is located further most away from the base to a low position where a circular saw blade, which is mounted on the motor unit and which is capable of being rotationally driven by a motor located within the motor unit, can engage with a work piece located on the base. A spring biases the motor unit to its upper most position.

Such saws can have a sliding feature wherein the motor unit, in addition to be able to perform a pivotal or chopping movement, can slide linearly across the base to perform a slide cut. Furthermore, these types of saw can include mechanisms by which they are able to perform miter and/or bevel cuts on work pieces located on the base. A saw which is capable of performing chop, sliding, bevel and miter cuts is known as a sliding compound miter saw.

PCT Application No. WO 98/18588 describes one construction of a sliding compound miter saw. PCT Application No. WO 98/18588 discloses a sliding compound miter saw which comprises a base 12 (using the same reference numbers as those used in PCT Application No. WO 98/18588) having a rotatable table 14 mounted within it. The rotatable table 14, in conjunction with a fence 26 fixed to the base 12, enables the sliding compound miter saw to perform miter cuts. Connected to the rear of the table 14 is a bevel mount 16 which is able to pivot about a horizontal axis in relation to the table 14. The pivotal movement of the bevel mount 16 in relation to the table 14 enables the sliding compound miter saw to perform bevel cuts.

Slideably mounted onto the bevel mount 16 are two guide rods 34 which are capable of sliding horizontally, backwards and forwards. The rods 34 enable the sliding compound miter saw to perform sliding cuts. Pivotally mounted on the end of the guide rods 34 is a motor unit 36, which comprises a motor 22 for rotationally driving a circular saw blade 18 mounted on a drive spindle on the motor unit 36. The pivotal movement of the motor unit 36 in relation to the guide rods 34 enable the saw to perform chop cuts.

European Application No. EP 0242733 discloses a different construction for a sliding compound mite saw to that disclosed in PCT Application No. WO 98/18588. European Application No. EP 0242733 discloses a sliding compound miter saw which comprises a base having a rotatable table mounted within it. The rotatable table, in conjunction with a fence fixed to the base, enables the sliding compound miter saw to perform miter cuts. Connected to the rear of the table is a bevel mount which is able to pivot about a horizontal axis in relation to the table. The pivotal movement of the bevel mount in relation to the table enables the sliding compound miter saw to perform bevel cuts.

Pivotally mounted onto the bevel mount are two guide rods which are capable of pivoting about an axis, parallel to the axis of rotation of the saw blade of the saw, between an upper and lower position. This enables the saw to perform chop cuts.

Slidingly mounted on the guide rods is a motor unit, which comprises a motor for rotationally driving the circular saw blade mounted on a drive spindle on the motor unit 36. The sliding movement of the motor unit along the guide rods enables the saw to perform sliding cuts.

The object of the present invention is to provide a locking mechanism for sliding compound miter saws to lock them in a storage position.

### SUMMARY

Accordingly there is provided a saw comprising a base assembly connected to a mounting portion, a saw unit pivotally mounted on the mounting portion to allow the saw unit to pivot towards or away from the base assembly, the saw unit having an output drive spindle upon which a circular saw blade can be rigidly mounted to be rotationally driven by a motor, the axis of rotation of the drive spindle being substantially parallel to the axis of pivot between saw unit and the mounting portion, pivotal biasing means to urge the saw unit to its upper most pivotal position, at least one pivotal guard pivotally mounted on the saw unit which can pivot from a first position, where it surrounds at least a portion of the lower edge of a saw blade when mounted on the spindle, to a second retracted position where the portion of the lower edge of the saw blade is exposed, and a guide mechanism which enables the saw unit to move linearly relative to the mounting portion in order to change the distance between the axis of rotation of the pivotal guard and the mounting portion; and guide biasing means to urge the saw unit towards a position closest to the mounting portion, and a locking mechanism which is capable of locking the position of the saw unit relative to the base assembly when the saw unit is in its uppermost pivotal position and in the position closest to the mounting portion.

### BRIEF DESCRIPTION OF THE DRAWINGS

An embodiment of the present invention will now be described with reference to the accompanying drawings of which:

FIG. 1 shows a perspective view of an embodiment of the saw;

FIG. 2 shows a side view of the saw with the saw assembly in the lower position;

FIG. 3 shows a side view of the saw with the saw assembly (partially cut away) in the upper position; and

FIG. 4 shows a partial side view a locking mechanism of the saw.

### DETAILED DESCRIPTION

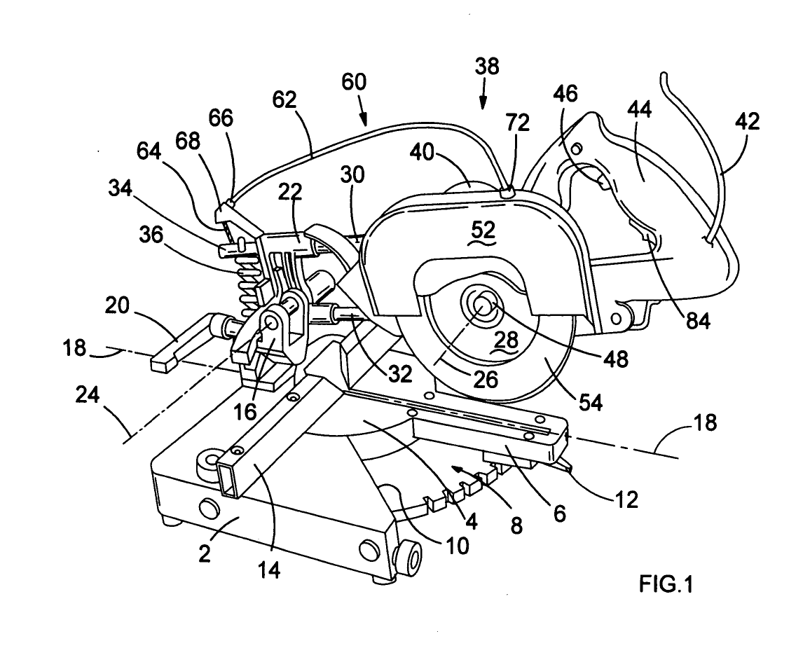

Referring to FIG. 1, the saw preferably comprises a base 2 to which a substantially circular table 4 may be mounted thereon. The circular table 4 can rotate about a vertical axis. An arm 6 is attached to the front of the circular table 4 which extends through a recess 8 formed in the front of the base 2 and then forward of the base 2. As the circular table rotates, the arm 6 preferably swings within the recess 8, the maximum amount of pivotal movement being limited by the sides 10 of the recess 8. A latch 12 may be attached to the underside of the end of the arm 6 which is capable of releasably locking the angular position of the arm 6 within the recess 8 in well known manner. A fence 14 is preferably rigidly attached to the base 2 and passes over the circular table 4.

A bevel support 16 may be pivotally attached to the rear of the circular table 4. The bevel support 16 can pivot about a horizontal bevel axis 18. The bevel support 16 can be locked in a range of angular positions relative to the circular table 4 using a locking handle 20. The mechanism by which the locking handle 20 locks the bevel support 16 is of no relevance to the present invention and therefore shall not be described in more any detail.

A slide support 22 may be pivotally mounted onto the bevel support 16. The slide support 22 can pivot about a chopping axis 24 which is substantially parallel to the axis of rotation 26 of a cutting blade 28 (described further below).

The ends of two straight rods 30, 32 may be rigidly mounted within the slide support 22. The rods 30, 32 are preferably prevented from sliding or rotating within the slide support 22. The rods 30, 32 may be located one above the other and are parallel to each other. A spring 36 may be attached to the end 34 of the top rod 30. The other end of the spring 36 is preferably attached to the bevel support 16. The spring 36 is preferably under tension, biasing the end 34 of the top rod 30 downwardly, biasing the ends of the two rods 30, 32 located remotely from the slide support 22 upwardly due to the pivotal connection of the slide support 22 to the bevel support 16.

A saw assembly 38 is preferably slideably mounted onto the two rods 30, 32. The saw assembly 38 preferably comprises a motor housing 40 in which is mounted an electric motor (not shown). The electric motor is powered via an electric cable 42. A handle 44 may be mounted on the rear of the motor housing 40. A trigger switch 46 is preferably mounted within the handle 44, which when depressed, activates the motor. A drive spindle 48 may project from the housing 40. A circular saw blade 28 is preferably rigidly mounted onto the drive spindle 48. When the motor is activated, the drive spindle rotates, rotatingly driving the saw blade 28. A fixed guard 52 may be rigidly mounted onto the motor housing 40 and surrounds the top cutting edge of the saw blade 28. A pivotal guard 54 is preferably pivotally mounted on the motor housing 40 and can pivot about the axis of rotation 26 of the saw blade 28. The pivotal guard 54 can pivot between an enclosed position where it surrounds the lower cutting edge of the saw blade 28 and a retracted position where it exposes the lower cutting edge of the saw blade 28. When the pivotal guard is in the retracted position, it is telescopically pivoted into the fixed guard 52. A pivotal guard spring (not shown) biases the pivotal guard 54 to the enclosed position.

The saw assembly 38 can slide along the two rods 30, 32 towards or away from the slide support 22.

In use, a work piece may be placed on the base 2 and circular table 4 against the fence 14. The pivotal movement of the circular table 4 about the vertical axis allows the saw to perform miter cuts on the work piece. The pivotal movement of the bevel support 16 in relation to the circular table 4 about the bevel axis 18 allows the saw to perform bevel cuts on the work piece. The pivotal movement of the slide support 22 on the bevel support 16 about the chopping axis 24 allows the saw to perform chop cuts on the workpiece. The sliding movement of the saw assembly 38 along the two rods 30, 32 allows the saw to perform sliding cuts on the work piece.

The saw preferably comprises a pivotal guard actuating mechanism. The pivotal guard actuating mechanism may cause the pivotal guard to pivot to its retracted position when the saw assembly is pivoted about the chopping axis 24 from its upper position to its lower position. The spring 36 preferably biases the saw assembly 38 to pivot about the chopping axis 24 to its uppermost position. In this position, the pivotal guard 54 encloses the lower edge of the cutting blade 28. As the saw assembly is pivoted downwardly towards the circular table 4, the pivotal guard actuating mechanism causes the guard 54 to retract into the fixed guard 52, exposing the lower cutting edge of the blade 28.

The pivotal guard actuating mechanism will now be described in more detail with references to FIGS. 1, 2 and 3. The pivotal guard actuating mechanism preferably comprises a Bowden cable 60. The Bowden cable 60 may comprise an outer sleeve 62 and an inner cable 64. The Bowden cable 60 preferably has two ends, each end comprising two parts, one part being one end of the inner cable 64 and the other part being a corresponding end of the outer sleeve 62.

The first end of the Bowden cable 60 is preferably connected across the pivot joint formed between the bevel support 16 and the sliding support 22. The end 66 of the sleeve 62 of the first end of the Bowden cable is preferably rigidly connected to the sliding support 22 via a fixed support 68. The end 70 of the cable 64 of the first end of the Bowden cable 60 is connected to the bevel support 16.

The second end of the Bowden cable 60 may be connected across the pivot joint formed between the fixed guard 52 and the pivotal guard 54. The end 72 of the sleeve 62 of the second end of the Bowden cable 60 is preferably rigidly connected to the fixed guard 52. The end 74 of the cable 64 of the second end of the Bowden cable 60 is preferably connected to the pivotal guard 54. The cable 64, between its second end 74 and the fixed end 72 of the sleeve 62, may wrap around a tube 76 which surrounds the drive spindle 48.

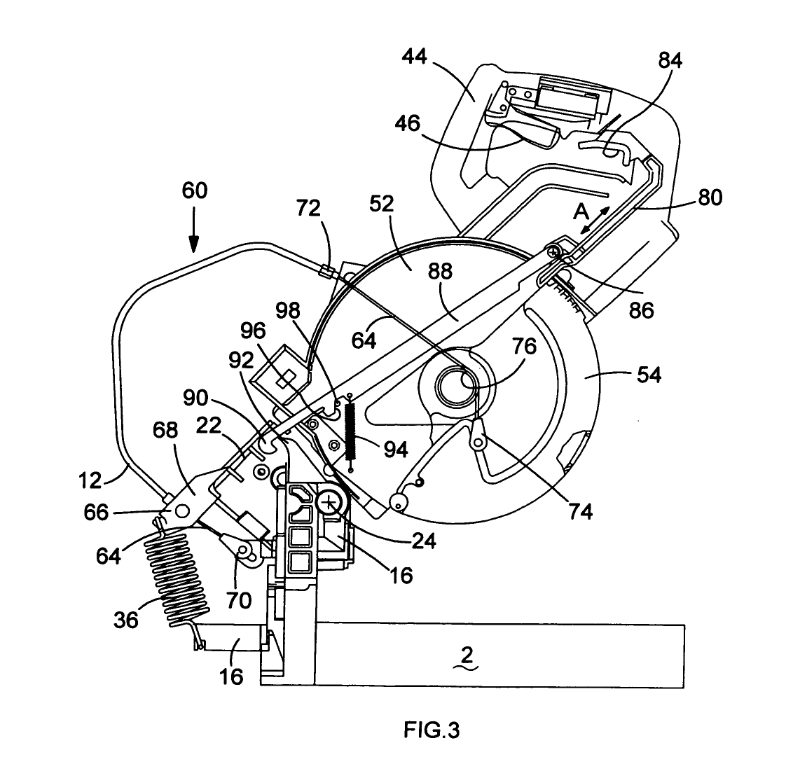

The pivotal guard actuating mechanism operates as follows: The saw assembly is preferably biased to its upper position (as shown in FIG. 3) by the spring 36 acting on the end 34 of the upper rod 30 (not shown in FIG. 3). The pivotal guard spring preferably biases the pivotal guard 54 to its enclosed position where it surrounds the lower cutting edge of the saw blade 28. When the pivotal guard is in this position, the end 74 of the cable 64 of the second end of the Bowden cable 60 is preferably pulled the furthest distance from the end 72 of the sleeve 62 of the second end of the Bowden cable 60 by the pivot guard spring. In contrast, the end 70 of the cable 64 of the first end of the Bowden cable 60 is preferably pulled into the sleeve 62, causing it to be at the shortest distance from the end 66 of the sleeve 62 of the first end of the Bowden cable 60.

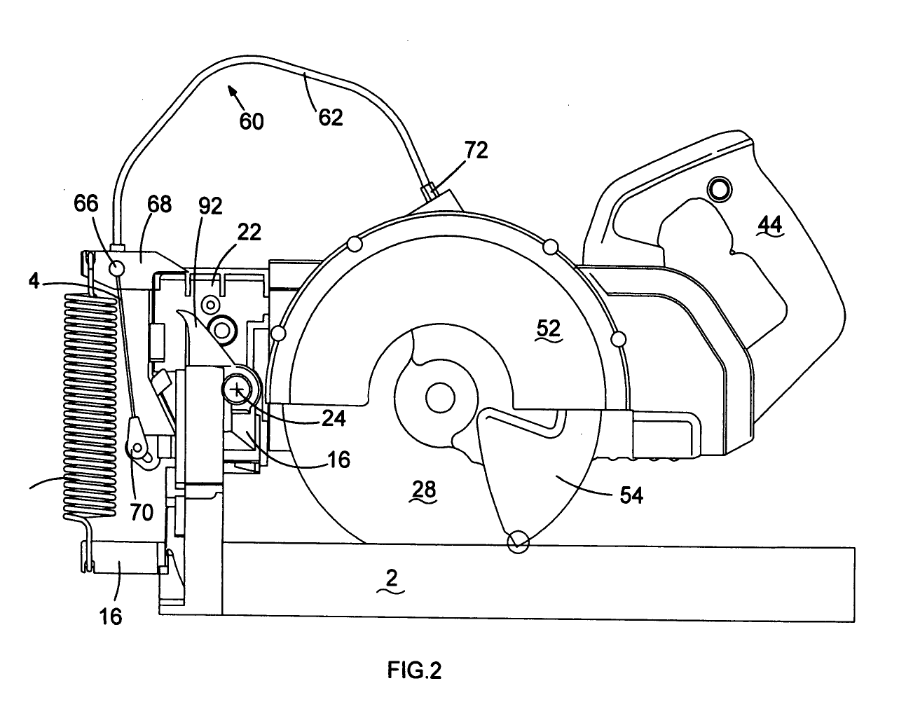

However, when the saw assembly is pivoted to its lowest position as shown in FIG. 2, the distance between the end 70 of the cable 64 of the first end of the Bowden cable 60 from the end 66 of the sleeve 62 of the first end of the Bowden cable 60 is forced to increase. This is due to the fact that the position of the end 70 of the cable 64 attached to the bevel support 16 remains stationary while the end 66 of the sleeve 62 attached to the sliding support 22 moves due to the relative pivotal movement between the bevel support 16 and the sliding support 22. The increase in this length results in a decrease in the length of cable 64 between the end 72 of the sleeve 62 connected to the fixed guard 52 and the end 74 of the cable 64 attached to the pivotal guard 54. As the cable 64 is retracted into the sleeve 62 at the second end of the Bowden cable 60, it travels around the tube 76, preferably causing the pivotal guard 54 to pivot to its retracted position.

When the saw assembly is pivoted to its highest position, the distance between the end 70 of the cable 64 of the first end of the Bowden cable 60 from the end 66 of the sleeve 62 of the first end of the Bowden cable 60 is preferably reduced allowing the pivotal guard 54 to pivot to its enclosed position due to the biasing force of the pivotal guard spring.

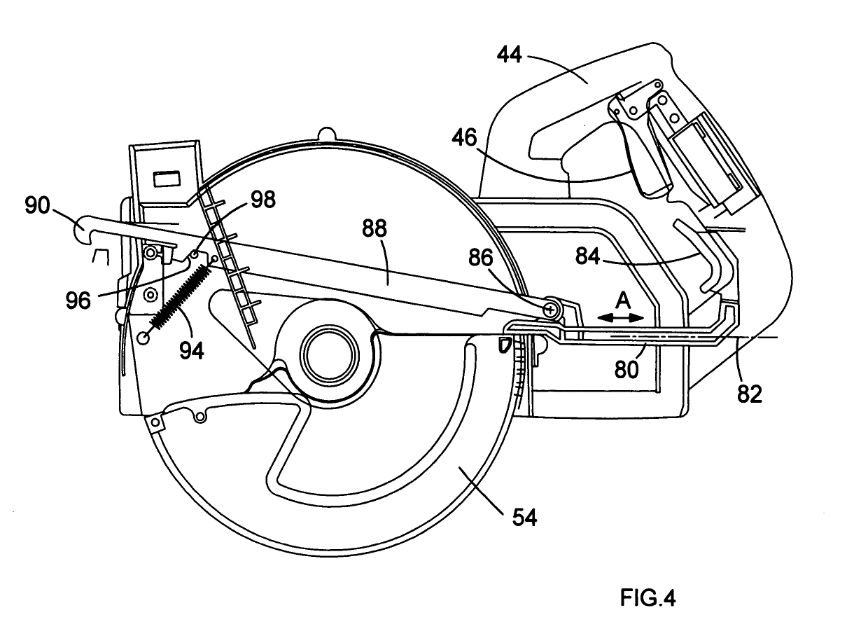

The saw also comprises a locking mechanism which will now be described with reference to FIG. 4. When the saw is not in use, it is desirable to be able to lock the position of the saw assembly 38 relative to the bevel support 16 in a storage position. When the saw is not in use, the saw assembly moves to its uppermost position (FIG. 3) due to the biasing force of the spring 36. The saw assembly 38 then preferably slides under gravity along the rods 30, 32 which are inclined due to the spring 36, towards and abuts against the sliding support 22. It is desirable to lock the saw assembly in this storage position and prevent accidental movement of the saw assembly 38 in relation to the bevel support 16.

The locking mechanism preferably comprises a retracting rod 80 slideably mounted within the handle 44. The retraction rod 80 can slide along axis 82 in the direction indicated by Arrow A as shown in FIG. 4. Formed on one end of the retraction rod 80 is a finger pad 84 which projects through the handle 44 and by which a user can engage the retraction rod 80 to release the locking mechanism.

Pivotally connected about point 86 to the other end of the retraction rod 80 is a locking rod 88. The locking rod 88 preferably extends pass the fixed guard 52 towards the bevel support 16. A hook 90 is preferably formed on the end of the locking rod 88 closest to the bevel support 16. A catch 92 (as seen in FIGS. 2 and 3) may be mounted on the bevel support 16. When the saw assembly 38 is in its storage position as shown in FIG. 3, the hook 90 preferably engages with the catch 92 to lock the saw assembly 38 in this position. When the saw assembly is locked in this position, it cannot pivot downwardly about axis 24 or slide along the rods 30, 32. The hook 90 is preferably kept in engagement with the catch 92 via a spring 94, connected between the locking rod 88 and the motor housing 40, which biases the hook 90 downwardly.

A cam surface 96 may be formed on the locking rod 88 in close proximity to the hook 90. A peg 98 is formed on the motor housing 40 which engages with the cam surface 96. The spring 94 biases the peg 98 and the cam surface 96 into engagement. When the hook 90 is engaged with the catch 92, the peg 98 is preferably located in the uppermost position along the cam surface 96 as shown in FIG. 4.

In order to release the hook form the catch 92, an operator preferably depresses the finger pad 84, moving it away from the bevel support 16 and causing the retraction rod 80 to slide along the axis 82. This in turn pulls the locking rod 88 away from the bevel support 16. This preferably results in the peg 98 sliding along the cam surface 96 causing the locking rod 88 to move upwards against the biasing force the spring 94. This causes the hook 90 to be moved above the catch 92, allowing the operator to move the saw assembly 38 using the handle 44 either by pivoting it about axis 24 or sliding it along rods 30, 32. When the operator ceases to depress the finger pad 84, the biasing force of the spring 94 moves the hook downwardly.

In order to re-engage the hook 90 with the catch 92, the operator preferably places the saw assembly in the storage position. As the saw assembly moves into the storage position, the hook 90 preferably rides over and then engages with the catch 92 due to its shape.

Persons skilled int eh art may recognize other alternatives to the means disclosed herein. However, all these additions and/or alterations are considered to be equivalents of the present invention.

1. A saw comprising:
a base assembly including a mounting portion;
a saw unit pivotally mounted to the mounting portion to allow the saw unit to pivot towards or away from the base assembly about a first axis, the saw unit having a motor, an output drive spindle connected to the motor and a circular saw blade mounted to the drive spindle, the drive spindle having a rotational axis substantially parallel to the first axis;
at least one pivotal guard pivotally mounted on the saw unit, the at least one pivotal guard being pivotable from a first position where it surrounds at least a portion of the lower edge of the saw blade, to a second retracted position where the portion of the lower edge of the saw blade is exposed;
a guide mechanism connected to the mounting portion and the saw unit, allowing the saw unit to move linearly relative to the mounting portion in order to change the distance between the rotational axis of the drive spindle and the mounting portion; and
a locking mechanism for locking the saw unit relative to the base assembly when the saw unit is in its uppermost pivotal position and in a position closest to the mounting portion.

2. The saw of claim 1 further comprising a pivotal biasing means for urging the saw unit to its upper most pivotal position.

3. The saw of claim 1 further comprising a guide biasing means for urging the saw unit towards a position closest to the mounting portion.

4. The saw of claim 1, wherein the saw unit is connected to a support portion which is pivotally mounted on the mounting portion to allow the saw unit to pivot towards or away from the base assembly.

5. The saw of claim 4 further comprising a guide biasing means for urging the saw unit towards a position closest to the support portion.

6. The saw of claim 1, wherein the locking mechanism comprises a hook mounted on one of the saw unit and the mounting portion and a catch mounted on the other of the saw unit and the mounting portion, where the hook and catch engage to lock the position of the saw unit relative to the base assembly.

7. The saw of claim 6, further comprising a first spring for maintaining the hook in engagement with the catch.

8. The saw of claim 6, wherein the locking mechanism further comprises a release mechanism connected to the hook for disengaging the hook from the catch when a disengagement force is applied.

9. The saw of claim 8, wherein the release mechanism comprising a cam surface mounted on one of the saw unit and the hook, and a cam follower mounted on the other of the saw unit and the hook and in engagement with the cam surface, the cam surface and cam follower being arranged so that when a disengagement force is applied to the hook, the cam follower slides along the cam surface to move the hook out of engagement of the catch.

10. The saw of claim 9, further comprising a first spring for biasing the cam follower to slide to a preset position along the cam surface.

11. The saw of claim 9, wherein the disengagement force can be applied by an operator asserting pressure onto a pad connected to the hook via at least one rod.

12. The saw of claim 1, wherein the mounting portion is connected to the saw unit via at least one rail.

13. The saw of claim 12, wherein one of the mounting portion and the saw unit is fixed to the at least one rail and the other of the mounting portion and the saw unit is slideable along the at least one rail (30, 32).

14. The saw of claim 12, further comprising a guide biasing means for urging the saw unit towards a position closest to the mounting portion.

15. The saw of claim 14 wherein the guide biasing means comprises the at least one rail angled relative to the base assembly so as to urge the saw unit to slide towards a position closest to the mounting portion.

16. The saw of claim 15, wherein the at least one rail is biased towards the position where it is angled relative to the base assembly so as to urge the saw unit to slide towards a position closest to the mounting portion.
